(19) United States
(12) Patent Application Publication
(10) Pub. No.: US 2025/0063974 A1
(43) Pub. Date: Feb. 27, 2025

(54) ROW UNIT HAVING PARALLEL LINKAGE ASSEMBLY WITH INTEGRATED ACTUATOR MOUNTS AND RELATED IMPLEMENTS

(71) Applicant: CNH Industrial America LLC, New Holland, PA (US)

(72) Inventor: Brian Michael Craig, Congerville, IL (US)

(21) Appl. No.: 18/807,261

(22) Filed: Aug. 16, 2024

Related U.S. Application Data
(60) Provisional application No. 63/578,015, filed on Aug. 22, 2023.

(51) Int. Cl. A01B 63/32; A01B 49/02

(52) U.S. Cl. CPC A01B 63/32; A01B 49/027

(57) ABSTRACT

An agricultural row unit includes a row unit frame and at least one downforce actuator configured to apply a downward biasing force against the row unit frame. The row unit also incudes a linkage assembly provided in operative association with the row unit frame and the downforce actuator(s). The linkage assembly includes a plurality of linkages, with each of the linkages extending between a proximal end coupled to the row unit frame and a distal end configured to be coupled to a toolbar of an associated implement. The linkage assembly also includes a mounting pin coupled to and extending directly between opposed linkages of the linkages. A first end of the downforce actuator(s) is supported by the mounting pin relative to the opposed linkages, and a second end of the downforce actuator(s) is coupled to the row unit frame.

### CROSS-REFERENCE TO RELATED APPLICATIONS

The present application is based upon and claims the right of priority to U.S. Provisional Patent Application No. 63/578,015, filed Aug. 22, 2023, the disclosure of which is hereby incorporated by reference herein in its entirety for all purposes.

### FIELD OF THE INVENTION

The present subject matter relates generally to agricultural implements, such as strip tillage implements and, more particularly, to agricultural row units having a parallel linkage assembly with integrated actuator mounts and related implements incorporating such row units.

### BACKGROUND OF THE INVENTION

Many agricultural implements include row units for processing a narrow strip of soil during the performance of an agricultural operation. For instance, planters include planter row units for opening a furrow along a narrow strip of soil, depositing a seed within the furrow, and then subsequently closing the furrow. Similarly, strip-tillage implements include strip-tillage row units for tilling a narrow strip of soil to prepare the soil for subsequent planting.

Typically, row units are coupled to a toolbar of the associated implement via a linkage assembly, such as a four-bar linkage. Additionally, a downforce actuator is typically coupled directly between the toolbar and the row unit for providing a downward biasing force to the row unit in order to maintain proper engagement with the soil during the performance of an agricultural operation. The separate coupling of the linkage assembly and downforce actuator between the toolbar and row unit results in wasted space and other design issues.

Accordingly, an agricultural row unit having an improved linkage assembly with integrated actuator mounts would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to an agricultural row unit includes a row unit frame and at least one downforce actuator configured to apply a downward biasing force against the row unit frame, with the at least one downforce actuator extending lengthwise between a first end and a second end. The row unit also incudes a linkage assembly provided in operative association with the row unit frame and the at least one downforce actuator. The linkage assembly includes a plurality of linkages, with each of the plurality of linkages extending between a proximal end coupled to the row unit frame and a distal end configured to be coupled to a toolbar of an associated implement. The linkage assembly also includes a mounting pin coupled to and extending directly between opposed linkages of the plurality of linkages. The first end of the at least one downforce actuator is supported by the mounting pin relative to the opposed linkages, and the second end of the at least downforce actuator is coupled to the row unit frame.

In another aspect, the present subject matter is directed to an agricultural implement includes a toolbar and a row unit coupled to the toolbar, with the row unit including a row unit frame configured to support a plurality of ground-engaging tools. The implement also includes at least one downforce actuator configured to apply a downward biasing force against the row unit frame, with the at least one downforce actuator extending lengthwise between a first end and a second end. Additionally, the implement includes a linkage assembly coupled between the toolbar and the row unit. The linkage assembly includes a plurality of linkages, with each of the plurality of linkages extending between a proximal end coupled to the row unit frame and a distal end configured to the toolbar. The linkage assembly also includes a mounting pin coupled to and extending directly between opposed linkages of the plurality of linkages. The first end of the at least one downforce actuator is supported by the mounting pin relative to the opposed linkages, and the second end of the at least downforce actuator is coupled to the row unit frame.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of one embodiment of an agricultural implement in accordance with aspects of the present subject matter;

FIG. 2 illustrates a side view of one embodiment of a row unit suitable for use with the implement shown in FIG. 1 in accordance with aspects of the present subject matter;

FIG. 3 illustrates a perspective view of one embodiment of a linkage assembly suitable for use with the row unit shown in FIG. 2, particularly illustrating the linkage assembly installed relative to a main frame or backbone of the row unit;

FIG. 4 illustrates a rear view of the linkage assembly shown in FIG. 4 with a lower portion of the main frame of the row unit removed for purposes of illustration; and

FIG. 5 illustrates another perspective view of the linkage assembly shown in FIG. 3, particularly illustrating mounting pins and associated lock pins of the linkage assembly exploded away from the remainder of the linkage assembly in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to an agricultural row unit having a parallel linkage assembly with integrated actuator mounts. Specifically, in several embodiments, the linkage assembly may include parallel linkages configured to be coupled between the main frame or backbone of a row unit and a toolbar of an associated agricultural implement. In addition, the linkage assembly may incorporate suitable structure for mounting downforce actuators in association with the linkages. For example, as will be described below, internal actuator brackets may be provided between opposed linkages for supporting adjacent ends of the downforce actuators. In one embodiment, the actuator brackets may be configured to accommodate a mounting pin that extends between the opposed linkages, with the mounting pin coupling the adjacent ends of the downforce actuators to the parallel linkage assembly. The opposed ends of the downforce actuators may be coupled, for example, to the main frame or backbone of the row unit to allow the actuators to apply a downward biasing force against the frame during operation of the row unit.

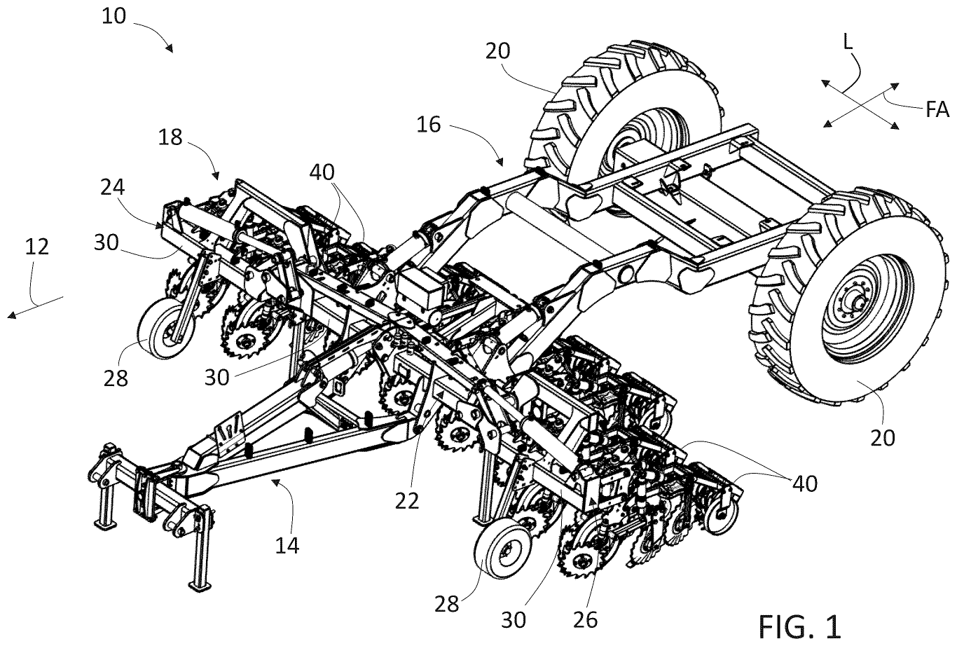

Referring now to the drawings, FIG. 1 illustrates a perspective view of one embodiment of an agricultural implement 10 in accordance with aspects of the present subject matter. In general, the implement 10 may be configured to be towed across a field in a forward direction of travel (e.g., as indicated by arrow 12 in FIG. 1) by a work vehicle (e.g., an agricultural tractor). As shown, the implement 10 is configured as a strip tillage implement. However, in other embodiments, the implement 10 may be configured as any other suitable type of implement, such as a seed-planting implement, a fertilizer-dispensing implement, and/or the like.

As shown in FIG. 1, the implement 10 includes a towbar assembly 14, a chassis assembly 16, and a toolbar assembly 18. As is generally understood, the towbar assembly 14 may be configured to allow the implement 10 to be coupled to a tow vehicle (e.g., a tractor) for towing the implement 10 along a field during the performance of a strip-tillage operation. For instance, the towbar assembly 14 may incorporate a hitch or other suitable coupling for connecting the implement 10 to a tow vehicle. In one embodiment, the chassis assembly 16 may be configured to support one or more storage tanks (not shown). For instance, the storage tank(s) may correspond to a fertilizer tank or any other suitable type of storage tank configured to store an agricultural material. Additionally, the chassis assembly 16 may be coupled to one or more pairs of chassis support wheels 20. For example, as shown in FIG. 1, a pair of support wheels 20 are coupled to the aft end of the chassis assembly 16 to support the implement 10 relative to the ground.

It should be appreciated that, in the illustrated embodiment, the chassis assembly 16 is positioned at the aft end of the implement 10 such that the toolbar assembly 18 is disposed between the towbar assembly 14 and the chassis assembly 16 along the fore-aft direction of the implement 10 (as indicated by arrow FA in FIG. 1). For instance, as shown in FIG. 1, toolbar assembly 18 is pivotably coupled at its forward end to the towbar assembly 14 and at its aft end to the chassis assembly 16. Alternatively, the chassis assembly 16 may be positioned between the towbar assembly 14 and the toolbar assembly 18 in the fore-aft direction FA of the implement 10 such that the toolbar assembly 18 is disposed at the aft end of the implement 10. In such an embodiment, the forward end of the toolbar assembly 18 may be coupled to the aft end of the chassis assembly 16 (e.g., via connecting frame).

In several embodiments, the toolbar assembly 18 may be configured as a winged toolbar assembly. Specifically, as shown in FIG. 1, the toolbar assembly 18 includes a central toolbar section 22 and one or more wing toolbar sections coupled to and extending laterally (e.g., in the lateral direction L) from the central toolbar section 22 (e.g., a first wing toolbar section 24 coupled to one lateral end of the central toolbar section 22 and a second wing toolbar section 26 coupled to the opposed lateral end of the central toolbar section. 22). Additionally, as shown in FIG. 1, a wing support wheel 28 may be coupled to each wing toolbar section 24, 26 (e.g., at the front of each wing toolbar section 24, 26) to support the toolbar section 24, 26 relative to the ground. In one embodiment, the wing support wheels 28 may be configured to function as gauge wheels for the wing toolbar sections 24, 26.

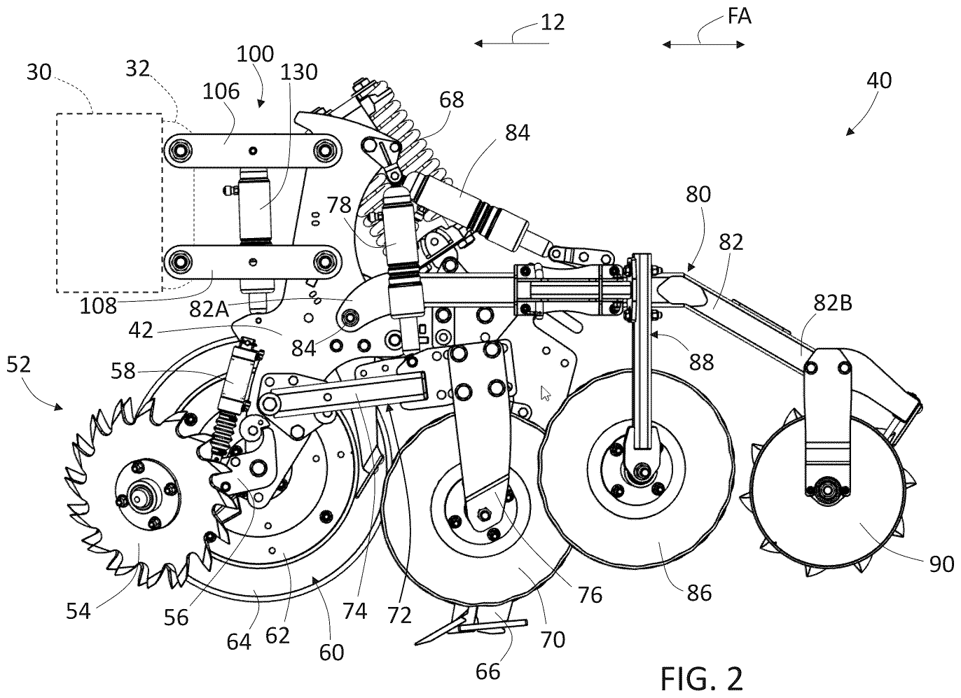

As is generally understood, each of the various toolbar sections 22, 24, 26 may include one or more laterally extending toolbars 30 configured to support a plurality of row units 40. For instance, as will be described below, each row unit 40 may be coupled to its respective toolbar 30 via a parallel linkage assembly 100 (FIGS. 2-5). In the illustrated embodiment, the row units 40 are configured as strip tillage units. As such, each row unit 40 may include one or more ground-engaging tools for working the soil in narrow strips extending in the forward direction of travel 12 of implement 10. For instance, in one embodiment, each row unit 40 may include one or more row cleaner discs, coulter discs, shanks or knives, finishing or conditioning units, and/or the like for tilling narrow strips of soil during the performance of a strip tillage operation. Additionally, each row unit 40 may also incorporate one or more components for supplying agricultural materials to the soil, such as injectors or tubes for directing agricultural material (e.g., fertilizer) supplied from a storage tank supported on the chassis assembly 16 (or from any other source) into the worked soil.

It should be appreciated that the configuration of the implement 10 described above and shown in FIG. 1 is provided only to place the present subject matter in an exemplary field of use. Thus, it should be appreciated that the present subject matter may be readily adaptable to any manner of implement configuration.

Referring now to FIG. 2, a side view of one embodiment of a row unit 40 suitable for use with the implement 10 shown in FIG. 1 is illustrated in accordance with aspects of the present subject matter. As shown, the row unit 40 includes a main frame or backbone 42 (referred to herein as simply the “row unit frame 42”) configured to be adjustably coupled to a toolbar (e.g., toolbar 30 and associated mounting bracket(s) 32) of the implement 10 via a linkage assembly 100. For example, as will be described in greater detail below, the row unit frame 42 may be coupled to the toolbar 30 via a linkage assembly 100 including one or more pairs of first and second linkages 106, 108, with one end of each linkage 106, 108 being pivotably coupled to the row unit frame 42 and the opposed end of each linkage 106, 108 being pivotably coupled to the toolbar 30 (e.g., via the associated mounting bracket(s) 32). Additionally, the row unit 40 may include one or more downforce actuators 130 provided in operative association with the linkage assembly 100 for applying a downward biasing force to the row unit 40. In one embodiment, the downforce actuators 130 may be passive actuators, such as air shocks or springs. Alternatively, the downforce actuators 130 may be actively controlled actuators, such as pneumatic or hydraulic cylinders.

Moreover, as shown in FIG. 2, the row unit 40 may include a plurality of ground-engaging tools coupled to and/or supported by the row unit frame 42. For instance, in several embodiments, the row unit 40 may include a row cleaner assembly or “row cleaner” 52 positioned at the forward end of the row unit 40 relative to the forward direction of travel 12. In general, the row cleaner 52 may be configured to break up and/or sweep away residue, dirt clods, and/or the like from the travel path of the various components positioned downstream or aft of the row cleaner 52. In one embodiment, the row cleaner 52 may include a pair of row cleaner discs 54 (only one of which is shown in FIG. 2), with each disc 54 being pivotably coupled to the row unit frame 42 via a respective row cleaner arm 56. As is generally understood, the row cleaner discs 54 may be toothed or spiked, such as by including a plurality of fingers or teeth extending radially outwardly from a central disc hub. As such, the discs 54 may be configured to roll relative to the soil as the implement 10 is moved across the field such that the teeth break up and/or sweep away residue and dirt clods. Additionally, as shown in FIG. 2, the row unit 40 may also include one or more row cleaner actuators 58 provided in association with the row cleaner 52. For instance, in the illustrated embodiment, the row unit 40 includes a pair of row cleaner actuators 58 (only one of which is shown in FIG. 2) configured to provide a downward biasing force against the row cleaner 52, with each row cleaner actuator 58 being coupled between the main frame 42 and a respective row cleaner arm 56. In one embodiment, the row cleaner actuators 58 may be passive actuators, such as air shocks or springs. Alternatively, the row cleaner actuators 58 may be actively controlled actuators, such as pneumatic or hydraulic cylinders.

Moreover, as shown in FIG. 2, the row unit 40 may also include a center coulter 60 positioned immediately aft of the row cleaner 52 relative to the forward direction of travel 12 of the implement 10. The center coulter 60 may generally be aligned with a longitudinal centerline of the row unit 40 such that the coulter 60 is positioned in the center of the row unit 40 relative to the lateral direction L of the implement 10 (i.e., the direction into and out of the page in FIG. 2). In one embodiment, the center coulter 60 may include a central hub 62 coupled to the row unit frame 42 for rotation relative thereto and a peripheral blade 64 extending radially outwardly from the hub 62 around its outer perimeter. The center coulter 60 may generally be configured to cut a slot or slit within the field along the center of the “row” being processed or formed by the row unit 40. Additionally, the center coulter 60 may also function together with the row cleaner 52 to ensure that residue and other trash is swept or moved laterally away from the travel path of further downstream components of the row unit 40. For instance, in one embodiment, as the row cleaner discs 54 rotate relative to the ground, the discs 54 may be configured to trap residue against the surface of the field. The blade 64 of the center coulter 60 may then slice or cut through the trapped residue extending between the pair of row cleaner discs 54, thereby allowing the cut residue to be swept away from the longitudinal centerline of the row unit 40 via the action of the row cleaner discs 54.

Referring still to FIG. 2, in several embodiments, the row unit 40 may include a centralized shank 66 mounted to the row unit frame 42 at a location aft of the central hub 60 relative to the forward direction of travel 12 of the implement 10. In one embodiment, the shank 66 may generally be aligned with the center coulter 60 along the longitudinal centerline of the row unit 60 (i.e., aligned with the center coulter 60 in the longitudinal direction of the implement 10). The shank 66 may be configured to break out the soil along the lateral width of the row being formed by the row unit 40 at a location aft of the center coulter 50. For example, the shank 66 may be aligned with the blade 64 of the center coulter 60 such that the shank 66 travels through and breaks open the slit or slot cut into the soil via the center coulter 60. As shown in FIG. 2, the row unit 40 may also include one or more shank actuators 68 provided in association with the shank 66 for providing a downward biasing force thereto. For instance, in the illustrated embodiment, the row unit 40 includes a pair of shank actuators 68, with each shank actuator 68 being coupled between the main frame 42 and the shank 66. In one embodiment, the shank actuators 68 may be passive actuators, such as air shocks or springs. Alternatively, the shank actuators 68 may be actively controlled actuators, such as pneumatic or hydraulic cylinders. In alternative embodiments, the shank 66 may be replaced with a different ground-engaging tool, such as centralized knife positioned immediately aft of the center coulter 60.

Additionally, in several embodiments, the row unit 40 may include a forward or first pair of side coulter discs 70 (only one of which is shown in FIG. 2) positioned immediately aft of the center coulter 60 relative to the forward direction of travel 12, with each first side coulter disc 70 being disposed along either side of the shank 60 such that the discs 70 are spaced apart from the shank 60 in the lateral direction L of the implement 10. In one embodiment, each first side coulter disc 70 is pivotably coupled to the row unit frame 42 via a first side coulter mount assembly 72. For instance, as shown in FIG. 2, the side coulter arm assembly 72 includes a mounting arm 74 and a support arm 76, with the mounting arm 74 being pivotably coupled to the frame 42 at one end and being coupled to the support arm 76 at the other end. The support arm 76 may, in turn, be coupled between the mounting arm 74 and its respective first side coulter disc 70 in a manner that allows the coulter disc 70 to rotate relative to the support arm 76 as the row unit 40 is being moved across the field. As shown in FIG. 2, the row unit 40 may also include one or more side coulter actuators 78 provided in association with the side coulters 78 for applying a downward biasing force thereto. For instance, in the illustrated embodiment, the row unit 40 includes a pair of side coulter actuators 78 (only one of which is shown in FIG. 2), with each side coulter actuator 78 being coupled between the row unit frame 42 and a respective coulter arm assembly 72. In one embodiment, the side coulter actuators 78 may be passive actuators, such as air shocks or springs. Alternatively, the side coulter actuators 78 may be actively controlled actuators, such as pneumatic or hydraulic cylinders.

In several embodiments, the side coulter discs 70 may function together with the central shank 66 to break out the soil along the width of the strip being worked or formed by the row unit 40. For instance, the side coulter discs 70 may be configured to “score” the soil to provide a pre-fracture at the desired width of the strip being formed. As an example, the side coulter discs 70 may be configured to run at a relatively shallow depth (e.g., 1-2 inches) to create scores or fracture lines” within the soil along the lateral edges of the row being formed. The shank 66 may, in turn, be configured to break out the hard soil across the lateral width extending between the fracture lines created by the side coulter discs 70.

Moreover, in several embodiments, the row unit 40 may include an aft frame assembly 80 coupled to the main row unit frame 42 for supporting additional ground-engaging tools of the row unit 40. As shown in FIG. 2, the aft frame assembly 80 may include a pair of aft frame members 82 (only one of which is shown in FIG. 2) extending between a forward end 82A and an aft end 82B, with the forward end 82A of each frame member 82 being pivotably coupled to the frame 42 at a forward pivot point 44. Each frame member 82 extends rearwardly from the pivot point 44 relative to the forward direction of travel 12 to its aft end 82B positioned adjacent to the aft end of the row unit 40. Additionally, in one embodiment, the row unit 40 may include one or more aft frame actuators 84 provided in association with the aft frame assembly 80 for providing a downward biasing force to the frame assembly 80 (and any ground-engaging tools supported thereby). For instance, in the illustrated embodiment, the row unit 40 includes a pair of aft frame actuators 84 (only one of which is shown in FIG. 2), with each aft frame actuator 84 being coupled between the main frame 42 and a respective aft frame member 82 of the aft frame assembly 80. In one embodiment, the aft frame actuators 84 may be passive actuators, such as air shocks or springs. Alternatively, the aft frame actuators 84 may be actively controlled actuators, such as pneumatic or hydraulic cylinders.

As shown in FIG. 2, in several embodiments, the aft frame assembly 80 may be configured to support an aft or second pair of side coulter discs 86 positioned aft or rearward of the forward or first pair of side coulter discs 70 (and aft of the shank 66) relative to the forward direction of travel 12, with each second side coulter disc 86 being disposed along either side of the longitudinal centerline of the row unit 40 such that the discs 86 are spaced apart from the centerline in the lateral direction L of the implement 10. In one embodiment, the second side coulter discs 86 may be configured to catch or block the soil coming off of the first side coulter discs 70 and shank 66 and redirect such soil back towards the center of the row being formed. As a result of redirecting the thrown soil back towards the center of the row, the aft or second side coulter discs 86 may function as “berm builders” to create a berm of soil along the centerline of the row unit 40. In such instance, the second side coulter discs 86 may be set to run at a relatively shallow depth (e.g., 1 inch or less) so that the coulter discs 86 can catch the soil without effectively tilling the soil. Alternatively, the second side coulter discs 86 may be set at a less shallow depth to allow the coulter discs 86 to perform shallow tillage (e.g., to widen the strip of worked soil beyond what the first side coulter discs 70 achieved) while still performing the function of directing soil into the right lateral shape to build a proper berm across the width of the row. In one embodiment, each second side coulter disc 86 is coupled to the aft frame assembly 80 via a second side coulter mount assembly 88. In one embodiment, the side coulter mount assembly 88 may be configured to allow the positioning of the second side coulter discs 86 to be adjusted relative to the other tools of the row unit 40, thereby allowing the coulter discs 86 to be set properly for performing their soil-catching function.

Moreover, as shown in FIG. 2, the row unit 40 may also include a finishing tool positioned at the aft end of the row unit 40. Specifically, in the illustrated embodiment, the row unit 40 includes a strip conditioner 90 coupled to the aft end 82B of the aft frame assembly 80. In general, the strip conditioner 90 may have any suitable configuration that allows it to perform its function as a finishing tool. In one embodiment, the strip conditioner 90 may be configured as a spider conditioner that functions to reduce the size of soil clods across the width of the row being formed. In other embodiments, a conditioning reel or basket may be used as the finishing tool.

It should be appreciated that the configuration of the row unit 40 described above and shown in FIG. 2 is provided only to place the present subject matter in an exemplary field of use. Thus, it should be appreciated that the present subject matter may be readily adaptable to any manner of row unit configuration.

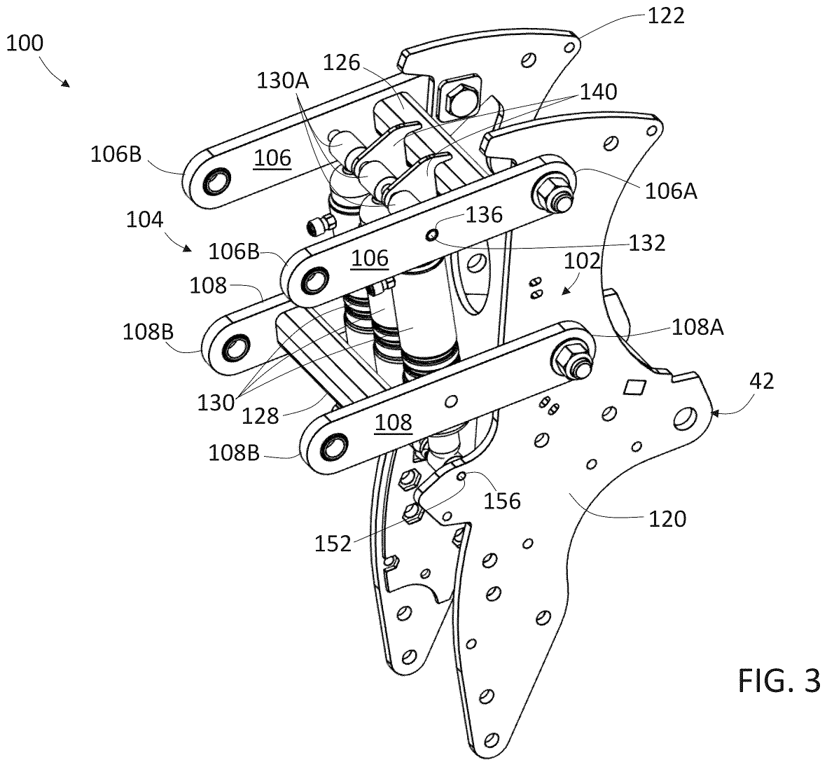

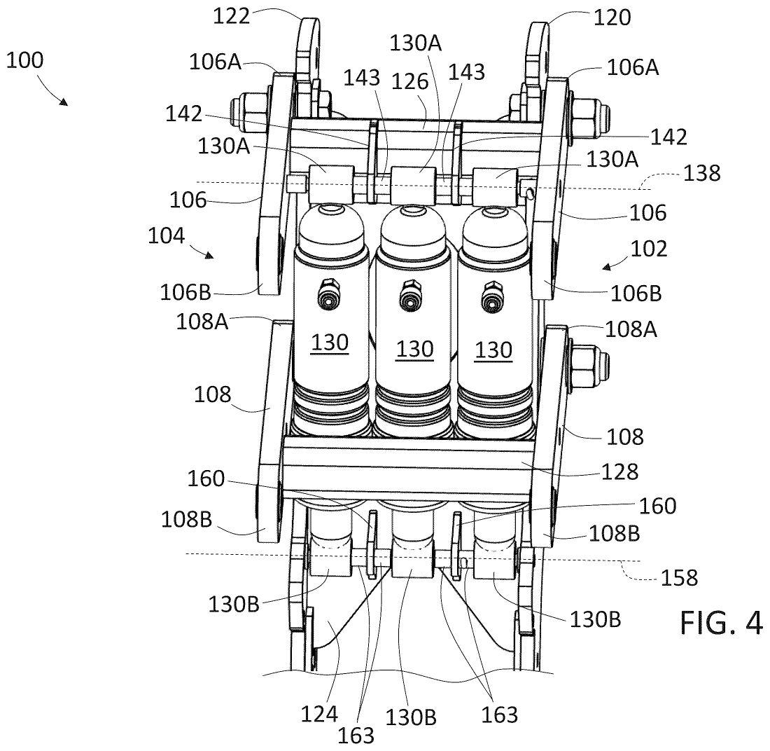

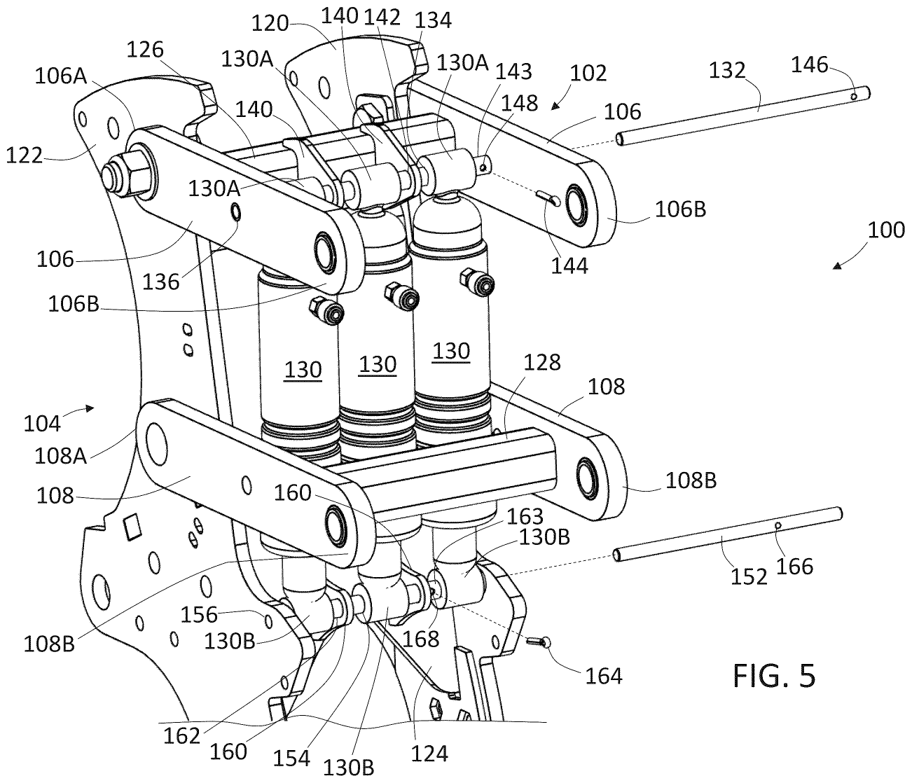

Referring now to FIGS. 3-5, several views of one embodiment of the linkage assembly 100 described above are illustrated in accordance with aspects of the present subject matter. Specifically, FIG. 3 illustrates a perspective view of the linkage assembly 100 as installed relative to a main frame or backbone of an agricultural row unit (e.g., row unit frame 42 shown in FIG. 2) and FIG. 4 illustrates a rear view of the linkage assembly 100 shown in FIG. 3 with a lower portion of the row unit frame 42 removed or cut-off for purposes of illustration. Additionally, FIG. 5 illustrates another perspective view of the linkage assembly 100 shown in FIG. 3 with a lower portion of the row unit frame 42 removed or cut-off for purposes of illustration, particularly illustrating mounting pins 132, 152 (and associated locking pins 144, 164) of the linkage assembly 100 exploded away from the remainder of the assembly 100 in accordance with aspects of the present subject matter. For purposes of discussion, the linkage assembly 100 will generally be described herein with reference to the row unit 40 shown and described above with reference to FIG. 2. However, in other embodiments, the linkage assembly 100 may be used in association with any other suitable row unit having any other suitable row unit configuration.

As shown in FIGS. 3-5, the linkage assembly 100 includes two pairs of parallel linkages (e.g., a first linkage pair 102 and a second linkage pair 104), with each linkage pair 102, 104 including an upper linkage 106 and a lower linkage 108. In general, the upper and lower linkages 106, 108 of each pair of parallel linkages 102, 104 may be configured to be coupled between the row unit frame 42 and an associated toolbar of the corresponding agricultural implement (e.g., the toolbar 30 of FIG. 2) to form a four-bar linkage therebetween. For example, as particularly shown in FIG. 3, the first pair of parallel linkages 102 is configured to be coupled between a first side frame member 120 of the row unit frame 42 and the toolbar 30 (FIG. 2), with a proximal end 106A, 108A of each of such linkages 106, 108 being pivotably coupled to the first side frame member 120 (e.g., via a pivot joint, such as a bolted connection) and a distal end 106B, 108B of each of such linkages 106, 108 being configured to be pivotably coupled to the toolbar 30 (e.g., via the associated bracket(s) 32 as shown in FIG. 2). Similarly, the second pair of parallel linkages 104 is configured to be coupled between a second side frame member 122 of the row unit frame 42 and the toolbar 30 (FIG. 2), with a proximal end 106A, 108A of each of such linkages 106, 108 being pivotably coupled to the second side frame member 122 (e.g., via a pivot joint, such as a bolted connection) and a distal end 106B, 108B of each of such linkages 106, 108 being configured to be pivotably coupled to the toolbar 30 (e.g., via the associated bracket(s) 32 as shown in FIG. 2). It should be appreciated that, in addition to the side frame members 120, 122, the row unit frame 42 may also include one or more structural frame members extending between and interconnecting the side frame members 120, 122 to create a rigid frame-like structure for supporting the various ground-engaging tools of the row unit 40. For instance, as particularly shown in FIG. 4, a central connecting frame member 124 of the row unit frame 42 may extend between and interconnect the side frame members 120, 122 to each other.

Additionally, in several embodiments, the linkage assembly 100 may also include one or more cross-members 126, 128 (e.g., structural tubes or bars) configured to tie together or otherwise structurally connect the opposed sets of linkages to each other. Specifically, as shown in FIGS. 3-5, an upper cross-member 126 is rigidly coupled directly between the upper linkages 106 while a lower cross-member 128 is rigidly coupled directly between the lower linkages 108. As a result, the cross-members 126, 128 may provide rigid connections between the upper and lower sets of linkages 106, 108.

Referring still to FIGS. 3-5, as indicated above, the linkage assembly 100 may also be configured to incorporate or accommodate one or more downforce actuators 130. Specifically, as shown in FIGS. 3-5, a set of three downforce actuators 130 are provided in operative association with the linkage assembly 100. However, in other embodiments, a different number of downforce actuators 130 may be provided in operative association with the linkage assembly 100. For instance, in the illustrated embodiment, the linkage assembly 100 is configured to accommodate one, two, or three actuators 130, depending on the number of actuators needed in association with operation of the corresponding row unit 40. In alternative embodiments, the linkage assembly 100 may be configured to accommodate any other suitable number of downforce actuators 130, such as two or fewer actuators or four or more actuators. It should be appreciated that, in the illustrated embodiment, the downforce actuators 130 are configured as air shocks or springs. However, as indicated above, the downforce actuators 130 may generally be configured as any suitable actuators, such as any suitable passive or active actuators.

As shown in FIGS. 3-5, each downforce actuator 130 may be configured to extend lengthwise between a first or upper end 130A and a second or lower end 130B, with the first end 130A of each actuator 130 configured to be coupled to and supported by the linkage assembly 100 and the second end 130B of each actuator 130 configured to be coupled to and supported by the row unit frame 42. Specifically, in the illustrated embodiment, the first ends 130A of the actuators 130 are configured to be coupled to the linkage assembly 100 via a first mounting pin 132 (see FIG. 3 for the pin 132 as installed and FIG. 5 for the pin 132 exploded away) extending between the upper linkages 106. For example, the first end 130A of each actuator 130 may be configured as a pivot connection end defining a through-hole 134 (FIG. 5—one of which is labeled) for receiving the first mounting pin 132. Additionally, the upper linkages 106 of the linkage assembly 100 may define pin holes 136 (e.g., see FIG. 3 for the pin opening 136 defined in one of the upper linkages 106 and FIG. 5 for the pin opening 136 defined in the other upper linkage 106) aligned along a first pin axis 138 (FIG. 4) for receiving the mounting pin 132. In such an embodiment, by aligning the through-holes 134 defined in the first ends 130A of the actuators 130 with the pin holes 136 of the upper linkages 106, the first mounting pin 132 may be inserted through the aligned holes 134, 136 along the first pin axis 138 to couple the first ends 130A of the actuators 130 to the linkage assembly 100. It should be appreciated that, in other embodiments, the first ends 130A of the actuators 130 may be configured to be coupled to the lower linkages 108 (e.g., via the first mounting pin 132) as opposed to the upper linkages 106.

Additionally, in several embodiments, to provide further structural support for the pinned mounting configuration associated with the first ends 130A of the actuators 130, the linkage assembly 100 may also include one or more first mounting brackets 140 for vertically supporting the first mounting pin 132. Specifically, as shown in FIGS. 3-5, a pair of first mounting brackets 140 are coupled to the upper cross-member 126 and extend outwardly therefrom to a distal end of each bracket 140. In such an embodiment, a bracket hole 142 (one of which is labeled in FIG. 5) may be defined in each mounting bracket 140 adjacent to its distal end for receiving the first mounting pin 132, thereby allowing the mounting brackets 140 to vertically support the central portion of pin 132 relative to the upper linkages 106. For instance, in one embodiment, the bracket holes 142 defined in the mounting brackets 140 may be configured to be aligned with the first pin axis 138 together with the pin holes 136 of the upper linkages 106 and the through-holes 134 of the upper ends 130A of the actuators 130 to allow the mounting pin 132 to be inserted therethrough when installing the pin 132 relative to such components.

It should be appreciated that, in several embodiments, the linkage assembly 100 may also incorporate bushings or spacers along the length of the first mounting pin 132 for providing proper spacing between the various components coupled thereto. Specifically, as shown in FIG. 4, bushings or spacers 143 may be installed along the axial length of the first mounting pin 132 on either side of each adjacent end 130A of each actuator 130 to space such actuator ends 130A apart from the upper linkages 106 and mounting brackets 140.

Moreover, the linkage assembly 100 may also include suitable pin lock features for retaining the first mounting pin 132 relative to the upper linkages 106 and the first ends 130A of the actuators 130. Specifically, as shown in the exploded view of FIG. 5, a locking pin 144 (e.g., a cotter pin) may be configured to be inserted through both a lock pin hole 146 defined through the mounting pin 132 and an associated lock pin hole 148 defined in an adjacent bushing 142 to lock the mounting pin 132 in a fixed axial position relative to the upper linkages 106 and to prevent the mounting pin 132 from backing or sliding out of the linkage assembly 100 during operation of the row unit 40.

Referring still to FIGS. 3-5, the second or lower ends 130B of the actuators 130 are configured to be coupled to the row unit frame 42 via a second mounting pin 152 (see FIG. 3 for the pin 152 as installed and FIG. 5 for the pin 152 exploded away) extending between the side frame members 120, 122 of the row unit frame 42. For example, the second end 130B of each actuator 130 may be configured as a pivot connection end having a through-hole 154 (FIG. 5—one of which is labeled) for receiving the second mounting pin 152. Additionally, the first and second side frame members 120, 122 may define pin holes 156 (e.g., see FIG. 3 for the pin hole 156 defined in the first side frame member 120 and FIG. 5 for the pin hole 156 defined in the second side frame member 122) aligned along a second pin axis 158 (FIG. 4) for receiving the second mounting pin 152. In such an embodiment, by aligning the through-holes 154 defined in the second ends 130B of the actuators 130 with the pin holes 156 of the side frame members 120, 122, the second mounting pin 152 may be inserted through the aligned holes 154, 156 along the second pin axis 158 to couple the second ends 130B of the actuators 130 to the row unit frame 42.

Additionally, in several embodiments, to provide further structural support for the pinned mounting configuration associated with the second ends 130B of the actuators 130, the linkage assembly 100 may include one or more frame or second mounting brackets 160 for vertically supporting the second mounting pin 152. Specifically, as shown in FIGS. 4 and 5, a pair of frame mounting brackets 160 are coupled to the connecting frame member 124 of the row unit 40 and extend outwardly therefrom to a distal end of each bracket 160. In such an embodiment, a bracket hole 162 (one of which is labeled in FIG. 5) may be defined in each mounting bracket 160 adjacent to its distal end for receiving the second mounting pin 152, thereby allowing the mounting brackets 160 to vertically support the central portion of pin 152 relative to the row unit frame 42. For instance, in one embodiment, the bracket holes 162 defined in the mounting brackets 160 may be configured to be aligned with the second pin axis 158 together with the pin holes 156 of the side frame members 120, 122 and the through-holes 154 of the lower ends 130B of the actuators 130 to allow the second mounting pin 152 to be inserted therethrough when installing the pin 152 relative to such components.

It should be appreciated that, in several embodiments, the linkage assembly 100 may also incorporate bushings or spacers along the length of the second mounting pin 152 for providing proper spacing between the various components coupled to the pin 152. Specifically, as shown in FIG. 4, bushings or spacers 163 may be installed along the axial length of the second mounting pin 152 on either side of each adjacent end 130B of each actuator 130 to space such actuator ends 130B apart from the side frame members 120, 122 and mounting brackets 160.

Moreover, the linkage assembly 100 may also include suitable pin lock features for retaining the second mounting pin 152 relative to the row unit frame 42 and the second ends 130B of the actuators 130. Specifically, as shown in the exploded view of FIG. 5, a locking pin 164 (e.g., a cotter pin) may be configured to be inserted through both a lock pin hole 166 defined through the second mounting pin 152 and an associated lock pin hole 168 defined in an adjacent bushing 163 to lock the second mounting pin 152 in a fixed axial position relative to the row unit frame 42 and to prevent the mounting pin 152 from backing or sliding out of the linkage assembly 100 or frame 42 during operation of the row unit.

It should be appreciated that, although the linkage assembly 100 is shown as including three downforce actuators 130 installed relative thereto, fewer actuators 130 can be installed relative thereto. Specifically, the illustrated linkage assembly 100 allows for the installation of up to three actuators 130. However, depending on the specific requirements for the row unit 40 and/or the operation being performed, it may only be necessary to install a single actuator 130 in association with the linkage assembly 100 or only two actuators 130 in association with the linkage assembly 100. When installing a single actuator 130, it may be desirable to install the actuator in the central actuator position (e.g., between the pairs of mounting brackets 140, 160). However, in other embodiments, the single actuator 130 may be installed in one of the other two actuator positions. Additionally, when installing two actuators 130, it may be desirable to install the actuators in the side actuator positions (e.g., along either side of the pairs of mounting brackets 140, 160). However, in other embodiments, the actuators 130 may be installed in any other combination of two actuator positions.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An agricultural row unit, comprising:
a row unit frame;
at least one downforce actuator configured to apply a downward biasing force against the row unit frame, the at least one downforce actuator extending lengthwise between a first end and a second end;
a linkage assembly provided in operative association with the row unit frame and the at least one downforce actuator, the linkage assembly comprising:
a plurality of linkages, each of the plurality of linkages extending between a proximal end coupled to the row unit frame and a distal end configured to be coupled to a toolbar of an associated implement, the plurality of linkages including a pair of opposed linkages;
a mounting pin coupled to and extending directly between the opposed linkages;
wherein:
the first end of the at least one downforce actuator is supported by the mounting pin relative to the opposed linkages; and
the second end of the at least downforce actuator is coupled to the row unit frame.

2. The agricultural row unit of claim 1, wherein the linkage assembly further comprises a cross-member extending directly between the opposed linkages and at least one mounting bracket coupled to and extending outwardly from the cross-member, the mounting pin extending through the at least one mounting bracket to support the mounting pin at a location between the opposed linkages.

3. The agricultural row unit of claim 1, further comprising a plurality of spacers spaced apart along an axial length of the mounting pin.

4. The agricultural row unit of claim 1, further comprising a removable locking pin configured to be inserted through a portion of the mounting pin to fix an axial position of the mounting pin relative to the opposed linkages.

5. The agricultural row unit of claim 1, wherein the plurality of linkages comprises first and second pairs of parallel linkages, each of the first and second pairs of parallel linkages comprising an upper linkage and a lower linkage, wherein the opposed linkages comprise the upper linkages of the first and second pairs of parallel linkages.

6. The agricultural row unit of claim 5, wherein each of the upper linkages defines pin hole aligned with a pin axis, the mounting pin being insertable through the pin holes of the upper linkages along the pin axis.

7. The agricultural row unit of claim 6, wherein the first end of the at least one downforce actuator defined a through-hole configured to receive the mounting pin along the pin axis.

8. The agricultural row unit of claim 1, wherein the at least one downforce actuator comprises at least two downforce actuators, the first end of the at least two downforce actuators being supported by the mounting pin relative to the opposed linkages.

9. The agricultural row unit of claim 1, wherein the mounting pin comprises a first mounting pin and further comprising a second mounting pin extending between opposed side frame members of the row unit frame, the second end of the at least one downforce actuator being supported by the mounting pin relative to the opposed side frame members.

10. The agricultural row unit of claim 9, wherein the row unit frame further comprises a connecting frame member connecting the first and second frame members to each other and at least one mounting bracket coupled to and extending outwardly from the connecting frame member, the second mounting pin extending through the at least one mounting bracket to support the second mounting pin at a location between the opposed side frame members.

11. An agricultural implement, comprising:
a toolbar;
a row unit coupled to the toolbar, the row unit including a row unit frame configured to support a plurality of ground-engaging tools;
at least one downforce actuator configured to apply a downward biasing force against the row unit frame, the at least one downforce actuator extending lengthwise between a first end and a second end;
a linkage assembly coupled between the toolbar and the row unit, the linkage assembly comprising:
a plurality of linkages, each of the plurality of linkages extending between a proximal end coupled to the row unit frame and a distal end configured to the toolbar, the plurality of linkages including a pair of opposed linkages;
a mounting pin coupled to and extending directly between the opposed linkages;
wherein:
the first end of the at least one downforce actuator is supported by the mounting pin relative to the opposed linkages; and
the second end of the at least downforce actuator is coupled to the row unit frame.

12. The agricultural implement of claim 11, wherein the linkage assembly further comprises a cross-member extending directly between the opposed linkages and at least one mounting bracket coupled to and extending outwardly from the cross-member, the mounting pin extending through the at least one mounting bracket to support the mounting pin at a location between the opposed linkages.

13. The agricultural implement of claim 11, further comprising a plurality of spacers spaced apart along an axial length of the mounting pin.

14. The agricultural implement of claim 11, further comprising a removable locking pin configured to be inserted through a portion of the mounting pin to fix an axial position of the mounting pin relative to the opposed linkages.

15. The agricultural implement of claim 11, wherein the plurality of linkages comprises first and second pairs of parallel linkages, each of the first and second pairs of parallel linkages comprising an upper linkage and a lower linkage, wherein the opposed linkages comprise the upper linkages of the first and second pairs of parallel linkages.

16. The agricultural implement of claim 15, wherein each of the upper linkages defines pin hole aligned with a pin axis, the mounting pin being insertable through the pin holes of the upper linkages along the pin axis.

17. The agricultural implement of claim 16, wherein the first end of the at least one downforce actuator defined a through-hole configured to receive the mounting pin along the pin axis.

18. The agricultural implement of claim 11, wherein the at least one downforce actuator comprises at least two downforce actuators, the first end of the at least two downforce actuators being supported by the mounting pin relative to the opposed linkages.

19. The agricultural implement of claim 11, wherein the mounting pin comprises a first mounting pin and further comprising a second mounting pin extending between opposed side frame members of the row unit frame, the second end of the at least one downforce actuator being supported by the mounting pin relative to the opposed side frame members.

20. The agricultural implement of claim 19, wherein the row unit frame further comprises a connecting frame member connecting the first and second frame members to each other and at least one mounting bracket coupled to and extending outwardly from the connecting frame member, the second mounting pin extending through the at least one mounting bracket to support the second mounting pin at a location between the opposed side frame members.
